(19) United States
(12) Patent Application Publication
(10) Pub. No.: US 2008/0158304 A1
(43) Pub. Date: Jul. 3, 2008

(54) INK-JET HEAD

(75) Inventor: Yoshiro Eto, Tagata-gun (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: TOSHIBA TEC KABUSHIKI KAISHA, Tokyo (JP)

(21) Appl. No.: 11/617,250

(22) Filed: Dec. 28, 2006

(51) Int. Cl. B41J 2/05

(52) U.S. Cl. 347/65

(57) ABSTRACT

An ink-jet head of the invention includes a head main body, an inflow port, an outflow port, an ink flow path, a nozzle, a heater and a guide unit. The ink flow path is formed inside the head main body to connect the inflow port and the outflow port. Ink flows in the inside of the ink flow path from the inflow port to the outflow port. The nozzle is formed on a side of the ink flow path. The heater is provided in the ink flow path. The heater generates a bubble pressure in the ink flow path, and causes the ink to be discharged from the nozzle. A bubble guide structure is provided in the ink flow path and guides the bubble pressure to the nozzle. The heater may be provided to be eccentric to the nozzle, or the heater may be disposed to be inclined.

### BACKGROUND OF THE INVENTION

1. Field of the Invention

The present invention relates to an ink-jet head to discharge ink toward a medium.

2. Description of the Related Art

For example, JP-A-2005-161633 discloses an ink-jet head of an ink circulation system. This ink-jet head is such that thermal energy is made to act on a liquid, and bubble pressure at the time of bubbling caused by the phase change of the liquid is generated so that the liquid is discharged. The ink-jet head includes a substrate provided with plural nozzles arranged in a row and heaters for discharging ink from the nozzles. Besides, the ink-jet head includes an ink reservoir unit along the arrangement of the nozzles. The ink-jet head includes a supply flow path to supply ink to the ink reservoir unit, and a slit to connect the nozzle and the ink reservoir unit. The supply flow path communicates with the ink reservoir unit, and distances from the communication unit to the respective nozzles are formed to be almost equal to each other.

In this ink-jet head, the distances from the communicating unit to the respective nozzles are made almost equal to each other, so that the temperature distribution of the ink is made uniform. By this, the liquid amounts of ink discharged from the respective nozzles are made uniform.

However, in the above ink-jet head, the ink does not circulate in the slit and the ink pressure chamber. Thus, there is a possibility that bubbles and dust are accumulated in the slit and the ink pressure chamber. Besides, when a certain nozzle continuously repeats the ink discharge, there is a possibility that the temperature of the ink in the slit is raised. Thus, the discharge liquid amount of ink becomes uneven, and there is a fear that the printing quality is degraded.

It is an object of the present invention to provide an ink-jet head which can prevent accumulation of ink.

### BRIEF SUMMARY OF THE INVENTION

In order to achieve the object, an ink-jet head according to an aspect of the invention includes a head main body, an inflow port provided in the head main body, an outflow port provided in the head main body, an ink flow path which is formed inside the head main body to connect the inflow port and the outflow port and through which ink flows from the inflow port to the outflow port, a nozzle formed on a side of the ink flow path, a heater (electro-heat conversion element) which is provided in the ink flow path, generates a bubble in the ink flow path, and causes the ink to be discharged from the nozzle, and a bubble guide structure which is provided in the ink flow path and causes pressure of the bubble to act on the nozzle.

In order to achieve the object, an ink-jet head according to another aspect of the invention includes a head main body, an inflow port provided in the head main body, an outflow port provided in the head main body, an ink flow path which is formed inside the head main body to connect the inflow port and the outflow port and through which ink flows from the inflow port to the outflow port, a nozzle formed on a side of the ink flow path, and a heater which is provided at a position closer to the inflow port than the nozzle in the ink flow path, generates a bubble in the ink flow path, and causes the ink to be discharged from the nozzle.

In order to achieve the object, an ink-jet head according to another aspect of the invention includes a head main body, an inflow port provided in the head main body, an outflow port provided in the head main body, an ink flow path which is formed inside the head main body to connect the inflow port and the outflow port and through which ink flows from the inflow port to the outflow port, a nozzle formed on a side of the ink flow path, and a heater which is provided on a side of the ink flow path and at a position opposite to the nozzle, generates a bubble in the ink flow path, and causes the ink to be discharged from the nozzle, wherein the heater is obliquely disposed so that as a point on the heater becomes close to the outflow port, a distance between the point and the nozzle becomes short.

Objects and advantages of the invention will become apparent from the description which follows, or may be learned by practice of the invention.

### BRIEF DESCRIPTION OF THE SEVERAL VIEWS OF THE DRAWING

The accompanying drawings illustrate embodiments of the invention, and together with the general description given above and the detailed description given below, serve to explain the principles of the invention.

FIG. 1 is a perspective view of an ink-jet head of a first embodiment.

FIG. 2 is a top view of the ink-jet head shown in FIG. 1.

FIG. 3 is a sectional view taken along line F3-F3 shown in FIG. 2.

FIG. 4 is a sectional view of an ink-jet head of a second embodiment.

FIG. 5 is a sectional view of an ink-jet head of a third embodiment.

FIG. 6 is a sectional view of an ink-jet head of a fourth embodiment.

### DETAILED DESCRIPTION OF THE INVENTION

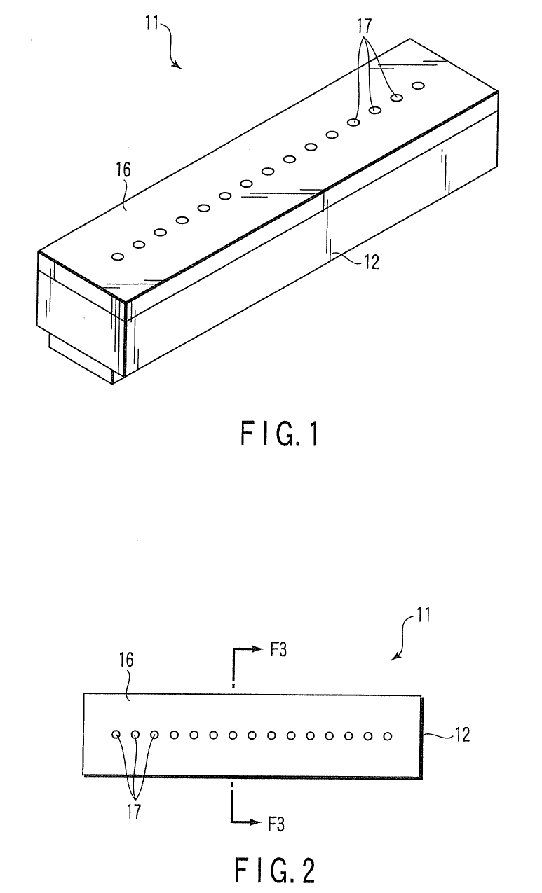

Hereinafter, a first embodiment of an ink-jet head will be described with reference to FIG. 1 to FIG. 3. This ink-jet head is mounted in an ink-jet recording apparatus, and discharges ink droplets toward a recording medium such as, for example, a sheet to form a character, a figure, a symbol and an image. The ink-jet head is constructed of a so-called ink circulation system head. Hereinafter, it is assumed that an upstream direction is a direction toward an inflow port, and a downstream direction is a direction toward an outflow port.

As shown in FIGS. 1, 2 and 3, an ink-jet head 11 includes a head main body 12, an inflow port 13 provided in the head main body 12, an outflow port 14 provided in the head main body 12, and an ink flow path 15 formed inside the head main body 12 so as to connect the inflow port 13 and the outflow port 14. The head main body 12 is formed to be rectangular. The head main body 12 includes a nozzle plate 16, and plural nozzles 17 are formed in the nozzle plate 16. The head main body 12 includes a wall unit 18 for dividing the ink flow path 15 into two parts.

The ink flow path 15 includes a first flow path 21 in which the nozzle 17 is formed halfway and a second flow path 22 which becomes a so-called common liquid chamber. The one second flow path 22 is formed inside the head main body 12 so as to extend over the whole head main body 12 in the longitudinal direction. The ink flow path 15 includes the plural first flow paths 21 to correspond to the plural nozzles 17 shown in FIG. 1. That is, the first flow paths 21 correspond to individual ink chambers corresponding to the respective nozzles 17. On the other hand, the nozzle 17 is positioned on a first side 21A of the first flow path 21 of the ink flow path 15. An ink 23 is made to flow through the inside of the first flow path 21 and the second flow path 22 of the ink flow path 15 in the direction from the inflow port 13 toward the outflow port 14.

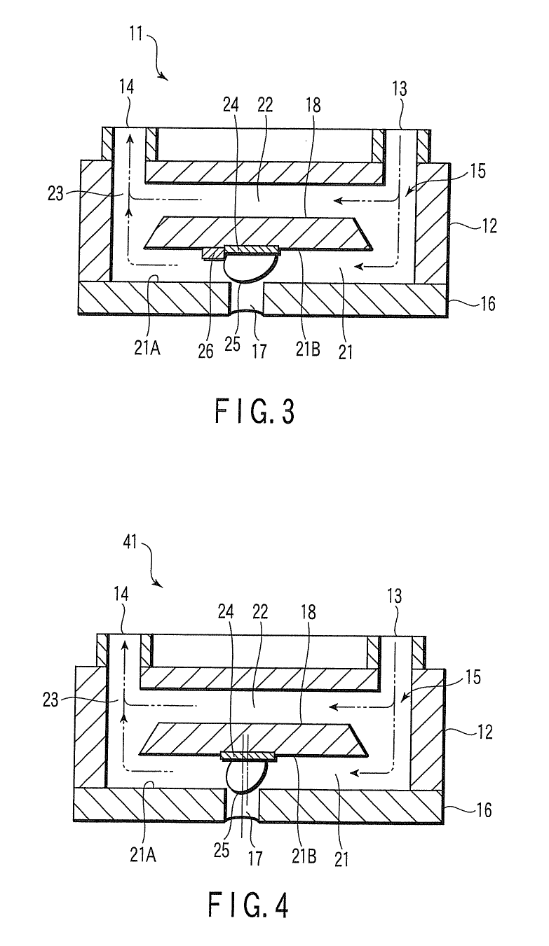

A heater 24 is provided inside each of the first flow paths 21 of the ink flow path 15. In FIG. 3, only the one nozzle 17, the one first flow path 21 and the one heater 24 are shown. That is, the first flow paths 21 and the heaters 24 are disposed in the direction in which the nozzles 17 are lined up. Incidentally, although the heater 24 is provided on a second side 21B of the ink flow path 15 and at a position opposite to the nozzle 17, no limitation is made to this. The heater 24 may be provided on the first side 21A of the ink flow path 15 where the nozzle 17 is disposed.

The heaters 24 are formed such that plural heat generating elements are lined up on a substrate. The heater 24 applies heat to the ink 23 and can boil the ink 23. The heater 24 generates a bubble 25 in the ink flow path 15 based on this principle, raises the pressure in the ink flow path 15, and can discharge the ink 23 from the nozzle 17.

A bubble guide structure 26 is provided inside the ink flow path 15, and the bubble guide structure 26 can guide the bubble 25 to the nozzle 17. The bubble guide structure 26 is provided on the first side 21B of the ink flow path 15 and in the vicinity of the nozzle 17 in the downstream direction. That is, the bubble guide structure 26 is located at the position closer to the outflow port 14 than the nozzle 17 and protrudes from the first side 21B of the ink flow path 15 to the nozzle plate 16.

The discharge of an ink droplet using the ink-jet head 11 of this embodiment will be described with reference to FIG. 3. In this ink-jet head 11, the ink 23 supplied from the inflow port 13 is ejected to the outside at the outflow port 14. As stated above, the discharge of the ink droplet is performed in a state where the ink 23 circulates in the inside of the head main body 12.

When the ink droplet is discharged, the heater 24 is driven to generate the bubble 25 in the first flow path 21 of the ink flow path 15. On the other hand, the ink 23 always circulates in the first flow path 21. Thus, the generated bubble 25 receives such a force that the bubble is made to flow in the downstream direction, that is, toward the outflow port 14. In this embodiment, the bubble guide structure 26 functions to hold the bubble 25 against the flow force of the ink 23. In this way, the bubble 25 is guided to the vicinity of the nozzle 17. As a result, the bubble pressure is properly applied, and the ink droplet is discharged from the nozzle 17.

According to the first embodiment, the bubble guide structure 26 to guide the bubble 25 to the nozzle 17 is provided in the first flow path 21 of the ink flow path 15. According to this structure, the bubble guide structure 26 can prevent the loss of the bubble pressure due to the flow of the bubble 25 toward the downstream direction. Thus, the state where the poor discharge occurs in the nozzle 17 is prevented, and the printing quality can be stabilized. Besides, according to this structure, since the state where the ink 23 always circulates can be kept in the vicinity of the nozzle 17, it is possible to prevent particles, such as bubbles or dust, from being accumulated in the vicinity of the nozzle 17. Besides, even if the temperature of the ink 23 is raised in the vicinity of the nozzle 17 by the repetition of the ink discharge, this ink 23 is ejected to the outside by the circulation. Thus, it is possible to prevent the temperature of the ink 23 from being raised in the vicinity of the nozzle 17. By this, the properties, such as viscosity, of the ink 23 become uniform, and the printing quality can be improved.

In this case, the bubble guide structure 26 can stably support the posture of the bubble 25 at the downstream position of the nozzle 17. Thus, the poor discharge caused by the flow of the bubble 25 in the direction toward the outflow port 14 can be prevented. Incidentally, the bubble guide structure 26 may be formed integrally with the wall unit 18.

A second embodiment of an ink-jet head 41 will be described with reference to FIG. 4. Although the ink-jet head 41 of the second embodiment is different from that of the first embodiment in the attachment position of a heater 24 and the presence or absence of a bubble guide structure 26, other portions are common to the first and second embodiments. Thus, the different portions will be mainly described, and the common portions are denoted by common symbols and their description will be omitted.

As shown in FIG. 4, the ink-jet head 41 includes a head main body 12, an inflow port 13 provided in the head main body 12, an outflow port 14 provided in the head main body 12, and an ink flow path 15 formed inside the head main body 12 so as to connect the inflow port 13 and the outflow port 14. The head main body 12 includes a nozzle plate 16, and plural nozzles 17 are formed in the nozzle plate 16.

The heater 24 for discharging an ink 23 from the nozzle 17 is provided inside the ink flow path 15. The heater 24 is provided on a second side 21B of the ink flow path 15 and at a position opposite to the nozzle 17. In more detail, the heater 24 is not disposed at the position exactly opposite to the nozzle 17, but is disposed to be shifted in the upstream direction with respect to the nozzle 17. That is, the heater 24 is provided at the position closer to the inflow port 13 than the nozzle 17. Thus, the heater 24 is disposed at the position eccentric to the center axis of the aperture of the nozzle 17.

It is preferable that the attachment position of the heater 24 is suitably set in accordance with the flow amount of the circulating ink 23, the liquid amount of the ink 23 discharged from the nozzle 17 and the like. That is, when the liquid amount of the ink 23 discharged from the nozzle 17 is large, the circulation flow amount of the ink 23 becomes large. Besides, when the liquid amount of the ink 23 discharged from the nozzle 17 is small, the circulation flow amount of the ink 23 becomes small. Thus, in the case of the ink-jet head in which the circulation flow rate of the ink 23 is large, the distance of the shift in the upstream direction is made large with respect to the nozzle 17. On the other hand, in the case of the ink-jet head in which the circulation flow amount of the ink 23 is small, the distance of the shift with respect to the nozzle 17 is made small.

In the ink-jet head 41 of this embodiment, the discharge liquid amount of the ink 23 is small, and for example, the discharge liquid amount is from 1 pl to 2 pl. Thus, the attachment position of the heater 24 is placed to be shifted by a value experimentally obtained according to the flow amount of ink.

FIG. 4 shows only the one nozzle 17, the one first flow path 21, and the one heater 24. That is, the plural first flow paths 21 and the plural heaters 24 are arranged in the direction in which the nozzles 17 are lines up. Incidentally, the heater 24 is provided on the second side 21B of the ink flow path 15 and at a position opposite to the nozzle 17. In this embodiment, the bubble guide structure 26 is not provided in the first flow path 21 of the ink flow path 15.

The discharge of an ink droplet using the ink-jet head 41 of the second embodiment will be described with reference to FIG. 4. In this ink-jet head 41, the ink 23 supplied from the inflow port 13 is ejected to the outside at the outflow port 14. As stated above, the discharge of the ink droplet is performed in the state where the ink 23 circulates in the inside of the head main body 12, which is similar to the first embodiment.

When the ink droplet is discharged, the heater 24 is driven to generate a bubble in the first flow path 21 of the ink flow path 15. On the other hand, the ink 23 always circulates in the first flow path 21. Thus, the generated bubble 25 receives such a force that the bubble is made to flow in the downstream direction, that is, toward the outflow port 14. As shown in FIG. 4, the bubble 25 is formed obliquely in the direction toward the outflow port 14. In this embodiment, since the heater 24 is disposed in the upstream direction of the nozzle 17, the bubble 25 is guided to the vicinity of the nozzle 17. As a result, the ink droplet is discharged in a proper direction from the nozzle 17.

According to the second embodiment, the heater 24 is provided at the position closer to the inflow port 13 than the nozzle 17 in the ink flow path 15. In general, when the ink 23 is circulated in the vicinity of the nozzle 17, the loss control of the bubble pressure of the bubble 25 becomes difficult. According to this structure, in view of that the bubble 25 is made to flow by the flow of the ink 23, the heater 24 can be disposed at the position shifted in the upstream direction with respect to the nozzle 17. Thus, even in the state where the ink 23 circulates in the ink flow path 15, the bubble 25 can be properly guided to the nozzle 17. Besides, according to this structure, since the state where the ink 23 always circulates can be kept, it is possible to prevent particles, such as bubbles or dust, from being accumulated in the vicinity of the nozzle 17. Besides, the rise of temperature of the ink 23 in the vicinity of the nozzle 17 is prevented and the printing quality can be improved.

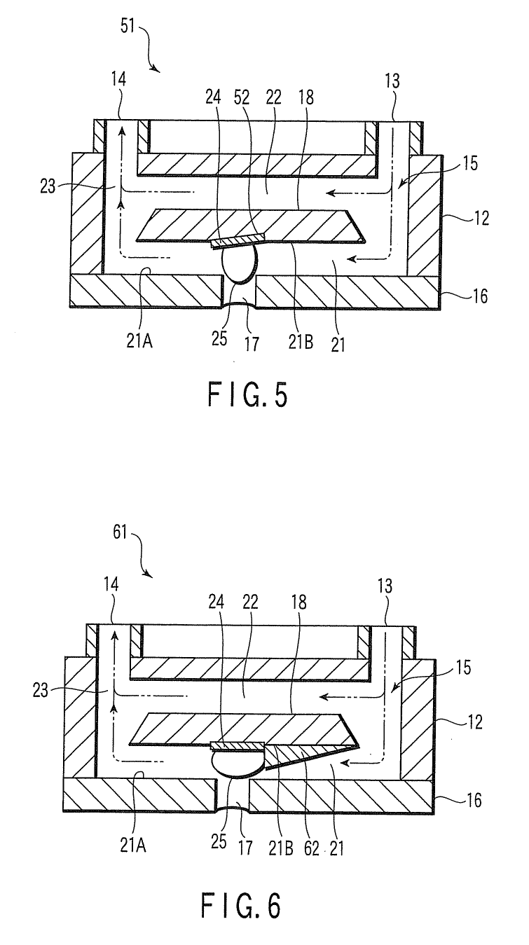

A third embodiment of an ink-jet head 51 will be described with reference to FIG. 5. Although the ink-jet head 51 of the third embodiment is different from that of the first embodiment in the attachment angle of a heater 24 and the presence or absence of a bubble guide structure 26, other portions are common to the first and second embodiments. Thus, the different portions will be mainly described, and the common portions are denoted by common symbols and their description will be omitted.

As shown in FIG. 5, the ink-jet head 51 includes a head main body 12, an inflow port 13 provided in the head main body 12, an outflow port 14 provided in the head main body 12, and an ink flow path 15 formed inside the head main body 12 so as to connect the inflow port 13 and the outflow port 14. The head main body 12 includes a nozzle plate 16, and plural nozzles 17 are formed in this nozzle plate 16.

A heater 24 for discharging an ink 23 from the nozzle 17 is provided in a first flow path 21 of the ink flow path 15. The heater 24 is placed obliquely to the nozzle 17. That is, the heater 24 is disposed obliquely so that as a point on the heater becomes close to the outflow port 14, the distance between the point and the nozzle 17 becomes short. Specifically, an oblique recess 52 is provided in a wall part 18, and the heat 24 is mounted in this recess 52.

It is preferable that the attachment angle of the heater 24 is suitably set according to the flow amount of the circulating ink 23, the liquid amount of the ink 23 discharged from the nozzle 17 and the like. That is, when the liquid amount of the ink 23 discharged from the nozzle 17 is large, the circulation flow amount of the ink 23 becomes large. When the liquid amount of the ink 23 discharged from the nozzle 17 is small, the circulation flow amount of the ink 23 becomes small. Thus, in the case of the ink-jet head in which the circulation flow amount of the ink 23 is large, the inclined angle with respect to the nozzle 17 is made large. On the other hand, in the case of the ink-jet head in which the circulation flow amount of the ink 23 is small, the inclined angle with respect to the nozzle 17 is made small.

In the ink-jet head 51 of this embodiment, the discharge liquid amount of the ink 23 is small, and for example, the discharge liquid amount is from 1 pl to 2 pl. Thus, the attachment angle of the heater 24 is such that it is placed to be inclined by, for example, several degrees with respect to the nozzle 17. In this embodiment, the bubble guide structure 26 is not provided in the first flow path 21 of the ink flow path 15.

FIG. 5 shows only the one nozzle 17, the one first flow path 21 and the one heater 24. That is, the plural first flow paths 21 and the plural heaters 24 are arranged in the direction in which the nozzles 17 are lined up.

The discharge of an ink droplet using the ink-jet head 51 of the third embodiment will be described with reference to FIG. 5. In this ink-jet head 51, the ink 23 supplied from the inflow port 13 is ejected to the outside at the outflow port 14. As stated above, the discharge of the ink droplet is performed in the state where the ink 23 circulates in the inside of the head main body 12, which is similar to the first embodiment.

When the ink droplet is discharged, the heater 24 is driven to generate a bubble 25 in the first flow path 21 of the ink flow path 15. Since the ink 23 circulates in the first flow path 21 also in this state, the generated bubble 25 receives such a force that the bubble is made to flow in the downstream direction, that is, toward the outflow port 14. However, since the heater 24 of this embodiment is placed obliquely, as shown in FIG. 5, the bubble 25 grows in the direction toward the nozzle 17. In this way, the ink droplet is properly discharged from the nozzle 17.

According to the third embodiment, the heater 24 is obliquely disposed so that as a point on the heater becomes close to the outflow port 14, the distance between the point and the nozzle 17 becomes small. In general, when the ink 23 is circulated in the vicinity of the nozzle 17, the control of the bubble 25 becomes difficult. According to this structure, in view of that the bubble 25 is made to flow by the flow of the ink 23, the heater 24 can be disposed to be inclined with respect to the nozzle 17. Thus, the direction in which the bubble 25 grows can be made oblique, and even in the state where the ink 23 circulates in the ink flow path 15, the bubble 25 can be guided straight to the nozzle 17. Besides, according to this structure, since the state in which the ink 23 always circulates can be kept, it is possible to prevent particles, such as bubbles or dust, from being accumulated in the vicinity of the nozzle 17. Besides, the rise of temperature of the ink 23 in the vicinity of the nozzle 17 is prevented and the printing quality can be improved.

FIG. 6 shows a fourth embodiment of an ink-jet head. This ink-jet head 61 includes a head main body 12, an inflow port 13 provided in the head main body 12, an outflow port 14 provided in the head main body 12, and an ink flow path 15 formed inside the head main body 12 so as to connect the inflow port 13 and the outflow port 14. The head main body 12 includes a nozzle plate 16, and plural nozzles 17 are formed in this nozzle plate 16.

A heater 24 for discharging an ink 23 from the nozzle 17 is provided inside the ink flow path 15. The heater 24 is provided on a second side 21B of the ink flow path 15 and a position opposite to the nozzle 17.

A bubble guide structure 62 is provided in the upstream direction to be closer to the inflow port 13 than the heater 24 and on the second side 21B of the ink flow path 15. The bubble guide structure 62 is provided to be inclined so as to approach the nozzle plate 16. That is, it protrudes toward the center of the ink flow path 15 from the position closer to the inflow port 13 than the heater 24 and on the side of the first ink flow path 21. The bubble guide structure 62 can stabilize the posture of the bubble 25. Incidentally, the bubble guide structure 62 may be formed integrally with the wall unit 18.

In the first to the fourth embodiments, the ink flow path 15 includes the first flow path positioned at the lower side, and the second flow path 22 positioned at the upper side. The nozzle 17 is provided at the first flow path 21. According to this structure, a large bubble is guided to the second flow path 22, and it is possible to prevent the large bubble from being mixed into the first flow path 21 where the nozzle 17 exists.

In addition, the ink-jet heads 11, 41, 51 and 61 can be variously modified and put into practice in the scope not departing from the gist of the invention. That is, in the second embodiment, the heater 24 is provided at the position closer to the inflow port 13 than the nozzle 17 so that the proper bubble 25 is formed, however, the shape itself of the nozzle 17 may be devised so that the ink 23 is properly discharged. Further, by combining the first to the fourth embodiments of the ink-jet head variously, effects of the invention can be further produced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the inventive as defined by the appended claims and equivalents thereof.

What is claimed is:

1. An ink-jet head comprising:
a head main body;
an inflow port provided in the head main body;
an outflow port provided in the head main body;
a first and a second ink flow paths which are formed inside the head main body to connect the inflow port and the outflow port and through which ink flows from the inflow port to the outflow port;
a nozzle formed on a side of the first ink flow path and in a nozzle plate;
a heater which is provided in the first ink flow path, generates a bubble in the ink flow path, and causes the ink to be discharged from the nozzle; and
a bubble guide structure which is provided in the first ink flow path and causes the bubble to act on the nozzle.

2. The ink-jet head according to claim 1, wherein the bubble guide structure protrudes toward the nozzle plate from a position closer to the outflow port than the heater and on a side of the first ink flow path.

3. The ink-jet head according to claim 1, wherein the bubble guide structure protrudes toward the nozzle plate from a position closer to the inflow port than the heater and on a side of the first ink flow path.

4. An ink-jet head comprising:
a head main body;
an inflow port provided in the head main body;
an outflow port provided in the head main body;
a first and a second ink flow paths which are formed inside the head main body to connect the inflow port and the outflow port and through which ink flows from the inflow port to the outflow port;
a nozzle formed on a side of the first ink flow path and in a nozzle plate; and
a heater which is provided at a position closer to the inflow port than the nozzle in the first ink flow path, generates a bubble pressure in the ink flow path, and causes the ink to be discharged from the nozzle.

5. An ink-jet head comprising:
a head main body;
an inflow port provided in the head main body;
an outflow port provided in the head main body;
a first and a second ink flow paths which are formed inside the head main body to connect the inflow port and the outflow port and through which ink flows from the inflow port to the outflow port;
a nozzle formed on a side of the first ink flow path and in a nozzle plate; and
a heater which is provided on a side of the first ink flow path and at a position opposite to the nozzle, generates a bubble pressure in the ink flow path, and causes the ink to be discharged from the nozzle,
wherein the heater is obliquely disposed so that as a point on the heater becomes close to the outflow port, a distance between the point and the nozzle becomes short.
